(19) United States
(12) Patent Application Publication
(10) Pub. No.: US 2026/0330902 A1
(43) Pub. Date: Oct. 22, 2026

(54) ARTICLE STORAGE DEVICE

(71) Applicant: Shenzhen Lingyue Chuangxiang Technology Co., Ltd., Shenzhen (CN)

(72) Inventors: Qingfeng Zhuang, Quanzhou (CN); Jianqing Dai, Shenzhen (CN)

(21) Appl. No.: 19/529,101

(22) Filed: Feb. 3, 2026

Related U.S. Application Data
(63) Continuation-in-part of application No. 19/322,660, filed on Sep. 8, 2025, now Pat. No. 12,601,217.
Application No. 19/322,660 is a continuation of application No. 19/066,210, filed on Feb. 28, 2025, now Pat. No. 12,435,559.
Application No. 19/322,660 is a continuation of application No. 19/066,215, filed on Feb. 28, 2025, now Pat. No. 12,435,560.

(30) Foreign Application Priority Data
Jan. 25, 2025 (CN) 202520172792.4
Jan. 25, 2025 (CN) 202520174444.0
Dec. 31, 2025 (CN) 202522844030.7

(51) Int. Cl. G07C 9/00; E05G 1/00; E05G 1/04

(52) U.S. Cl. CPC G07C 9/00563; E05G 1/005; E05G 1/04

(57) ABSTRACT

An article storage device is provided and includes a storage body portion and a cover body. The article storage device further includes: a palm vein collection module, configured to collect palm vein information; a signal processing module, being signally connected to the palm vein collection module and being configured to receive the palm vein information and generate at least one execution signal, which includes a first execution signal; and at least one execution module, including a lock module. The lock module is configured to receive the first execution signal to unlock the cover body.

### CROSS REFERENCE TO RELATED APPLICATIONS

This application is a continuation-in-part of the US patent application No. 19/322,660, filed on Sep. 8, 2025 and claims the foreign priority of the Chinese patent application No. 202522844030.7, filed on Dec. 31, 2025. The US patent application No. 19/322,660 is a continuation application of: the US patent application No. 19/066,210, filed on Feb.28, 2025; and the US patent application No. 19/066,215, filed on Feb. 28, 2025. The US patent application No. 19/322,660 claims foreign priorities of: the Chinese patent application No. 202520172792.4, filed on Jan. 25, 2025; and the Chinese patent application No. 202520174444.0, filed on Jan. 25, 2025. The disclosure of which is hereby incorporated by reference in their entireties.

### FIELD OF THE DISCLOSURE

The present disclosure relates to the field of article storage devices, and in particular, to an article storage device.

### BACKGROUND

For an article storage device in the art, a cover of the article storage device may be opened via a password unlocking mechanism or a fingerprint unlocking mechanism. However, the password unlocking mechanism may be time consuming, and a recognition location for the fingerprint unlocking mechanism may have a limited space, leading to difficulties in fingerprint recognition. Therefore, the article storage device may be not unlocked rapidly in emergency situations.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

An article storage device is provided and includes a storage body portion and a cover body. The article storage device further includes: a palm vein collection module, configured to collect palm vein information; a signal processing module, being signally connected to the palm vein collection module and being configured to receive the palm vein information and generate at least one execution signal, which includes a first execution signal; and at least one execution module, including a lock module. The lock module is configured to receive the first execution signal to unlock the cover body.

### BRIEF DESCRIPTION OF THE DRAWINGS

Illustrative embodiments of the present disclosure are described in detail below with reference to the attached drawing figures.

FIG. 1 is a structural schematic view of an entirety of an article storage device according to an embodiment of the present disclosure.

FIG. 2 is a schematic diagram of modules of the article storage device according to an embodiment of the present disclosure.

FIG. 3 is a schematic diagram of the article storage device according to an embodiment of the present disclosure, showing structures of a palm vein collection module and a signal processing module.

FIG. 4 is a schematic diagram of the article storage device according to an embodiment of the present disclosure, showing a plurality of wake-up modules.

FIG. 5 is a schematic diagram of the article storage device according to an embodiment of the present disclosure, showing a plurality of password collection modules and a plurality of fingerprint collection modules.

FIG. 6 is a schematic diagram of the article storage device according to an embodiment of the present disclosure, showing the palm vein collection module and an infrared wake-up module sharing one common infrared light source.

FIG. 7 is a schematic diagram of the article storage device according to an embodiment of the present disclosure, showing a display module.

### REFERENCE NUMERALS IN THE DRAWINGS

10-storage device body; 11-storage body portion; 12-cover body; 110-storage cavity; 111-obtaining window;

20-palm vein collection module; 21-first infrared emitter unit; 22-image capturing unit; 23-first signal transmission unit;

30-signal processing module; 31-recognition and comparison unit; 32-second signal transmission unit;

40-execution module; 41- lock module; b- alarm module; 43- setting module;

50- password collection module;

60- fingerprint collection module;

70- wake-up module; 71-infrared wake-up module; 72-microwave radar wake-up module; 73-key wake-up module; 74-touch wake-up module; 711-second infrared emitter unit; 712-photoelectric signal unit;

80-display module.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

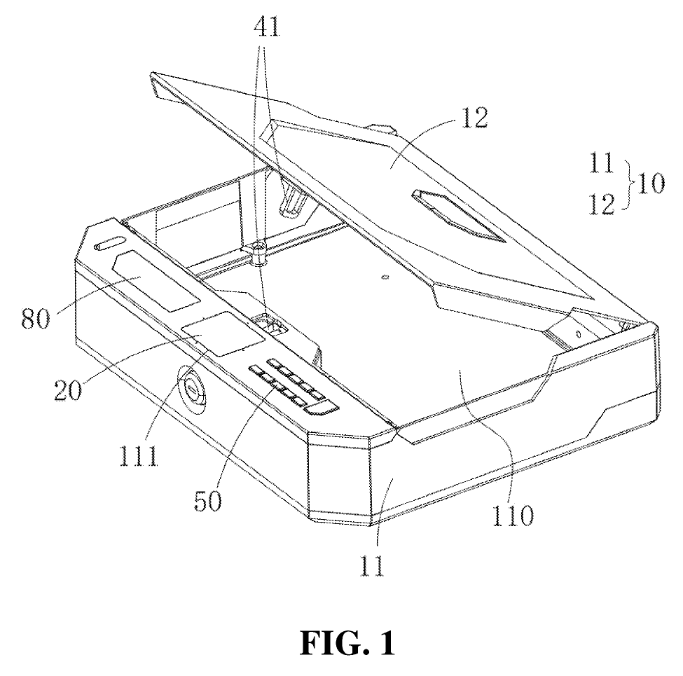

As shown in FIGS. 1 to 7, the present disclosure provides an article storage device including a storage body portion 11 and a cover body 12. The storage body portion 11 may define a storage cavity 110 therein for receiving articles. The cover body 12 may be movably mounted on the storage body portion 11 and may be opened to expose the or closed to cover the storage cavity 110. The storage body portion 11 and cover body 12 may cooperatively form a storage device body 10 of the article storage device. In addition, the storage device may further include a palm vein collection module 20, a signal processing module 30, and at least one execution module 40.

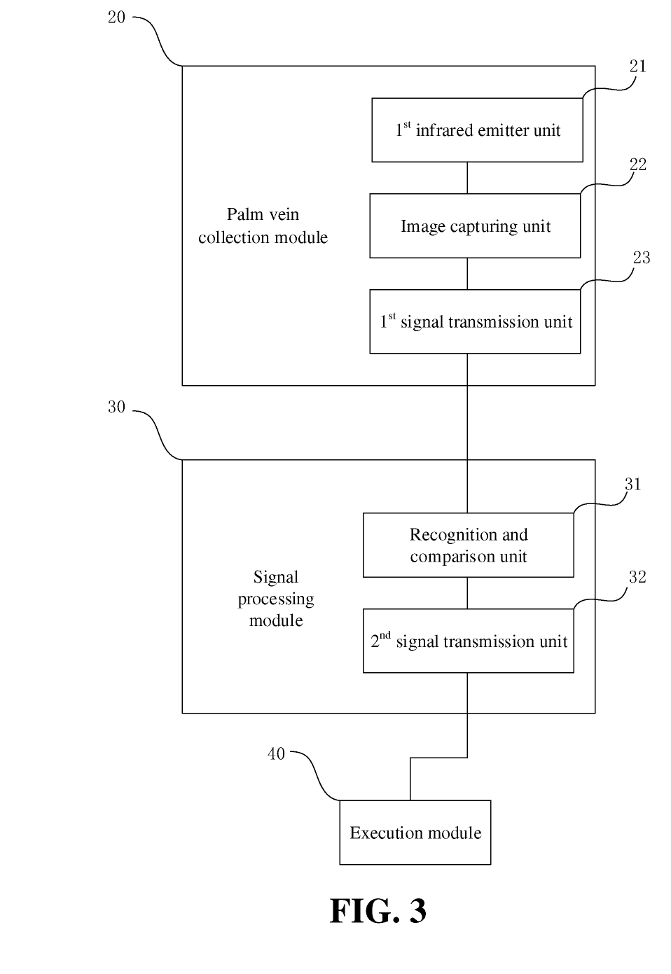

Specifically, the palm vein collection module 20 may be configured to obtain palm vein information. As shown in FIG. 3, the palm vein collection module 20 may include a first infrared emitter unit 21, an image capturing unit 22, and a first signal transmission unit 23. The first infrared emitter unit 21 may be configured to emit infrared light to illuminate palm veins of a user. The image capturing unit 22 may be configured to receive reflected light, which may be generated by the infrared light (emitted from the first infrared emitter unit 21) being reflected by the palm veins of the user; and may generate, based on the reflected light, a to-be-processed signal carrying the palm vein information. The first signal transmission unit 23 may transmit the to-be-processed signal to the signal processing module 30 in a form of an electrical signal or a wireless signal to be subsequently recognized and determined by the signal processing module 30. Specifically, the first infrared emitter unit 21 may be an infrared lamp, the image capturing unit 22 may be an infrared camera, and the first signal transmission unit 23 may be a wire, a pin, a Wi-Fi signal transmitter, a Bluetooth signal transmitter, and the like.

The signal processing module 30 may be signally connected to the palm vein collection module 20 and may be configured to receive the palm vein information. The signal processing module 30 may generate at least one execution signal, and the at least one execution signal may include a first execution signal. Specifically, the signal processing module 30 may compare the received palm vein information with user information that is stored in a preset information database. When the palm vein information successfully matches the user information stored in the preset information database, the signal processing module 30 may generate the first execution signal. For example, palm vein image information of the user may be stored in the preset information database to serve as the user information. As shown in FIG. 3, the signal processing module 30 may include a recognition and comparison unit 31 and a second signal transmission unit 32. The recognition and comparison unit 31 may receive the to-be-processed signal and may convert the to-be-processed signal into palm vein image information. The recognition and comparison unit 31 may then compare the palm vein image information with palm vein image information stored in the preset information database. When the converted palm vein image information matches the palm vein image information stored in the preset information database, it may be indicated that the current user may possess usage authorization of the storage device, and therefore, the first execution signal may be generated. Subsequently, the second signal transmission unit 32 may transmit the first execution signal to the at least one execution module 40 in a form of a wired signal or a wireless signal for subsequent operations. The recognition and comparison unit 31 may be a control circuit board integrated with an image processor. The control circuit board may be electrically or wirelessly connected to the first signal transmission unit 23. The second signal transmission unit 32 may be a wire, a pin, a Wi-Fi transmitter, a Bluetooth transmitter, or the like, which may be connected to the control circuit board. The control circuit board may be further integrated with other processors, so as to function as a master control board.

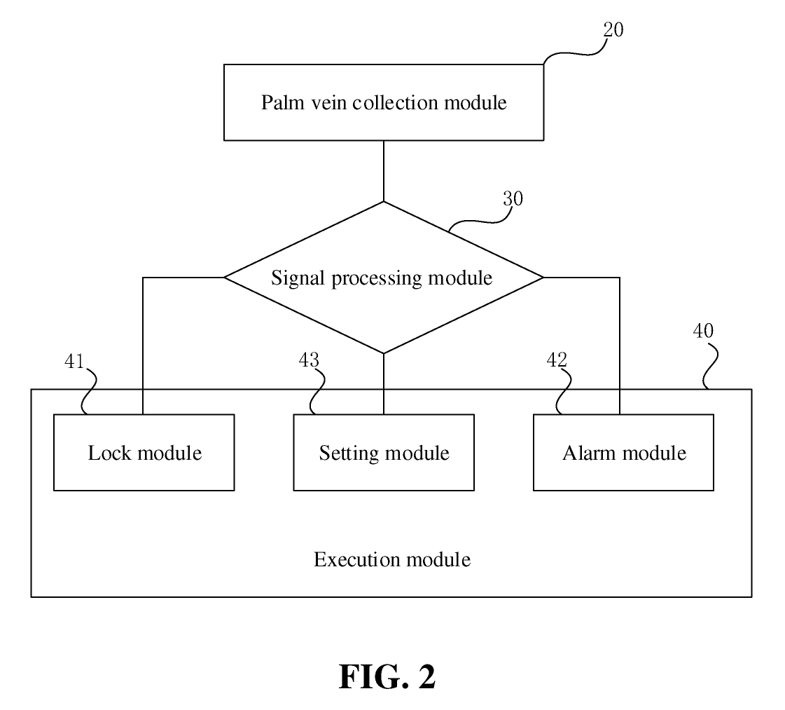

As shown in FIGS. 2, 4, and 5, the at least one execution module 40 may include modules with various functions, such as a lock module 41, an alarm module 42, and a setting module 43; and at least the lock module 41 may be arranged. The lock module 41 may be configured to be signally connected to the signal processing module 30 and may lock or unlock the cover body 12. Specifically, the lock module 41 may be a lock structure, such as an electrically-driven mechanical lock or an electromagnetic lock. When the lock module 41 receives the first execution signal, the lock module 41 may unlock the cover body 12, allowing the user to open the cover body 12 and access any article stored in the storage cavity 110. That is, the control circuit board may be electrically or wirelessly connected to the functional modules, such as the lock module 41, the alarm module 42, and the setting module 43.

In some embodiments, when the palm vein information fails to match the user information in the preset information database, the lock module 41 may not respond. In some embodiments, when the palm vein information fails to match the user information in the preset information database, it may be indicated the current user may be an unauthorized individual, and the signal processing module 30 may generate a second execution signal. The alarm module 42 may be configured to be signally connected to the signal processing module 30. When the alarm module 42 receives the second execution signal, the alarm module 42 may emit an alarm sound, or emit a voice prompt, or emit flashing light, or emit combination of the above. Correspondingly, the alarm module 42 may be an alarm device, a voice prompt device, a warning lamp, or a combination thereof.

Accordingly, for the article storage device in the present disclosure, a palm vein recognition unlocking function may be provided, the lock module 41 may be unlocked by recognizing the palm vein information of the user. An area of a body portion of the user for recognition may be larger, and the palm of the user may not need to directly contact the article storage device. Therefore, unlocking may be achieved, and responding for unlocking may be faster in time, and therefore, the article storage device in the present disclosure may be more applicable for rapid unlocking during emergencies.

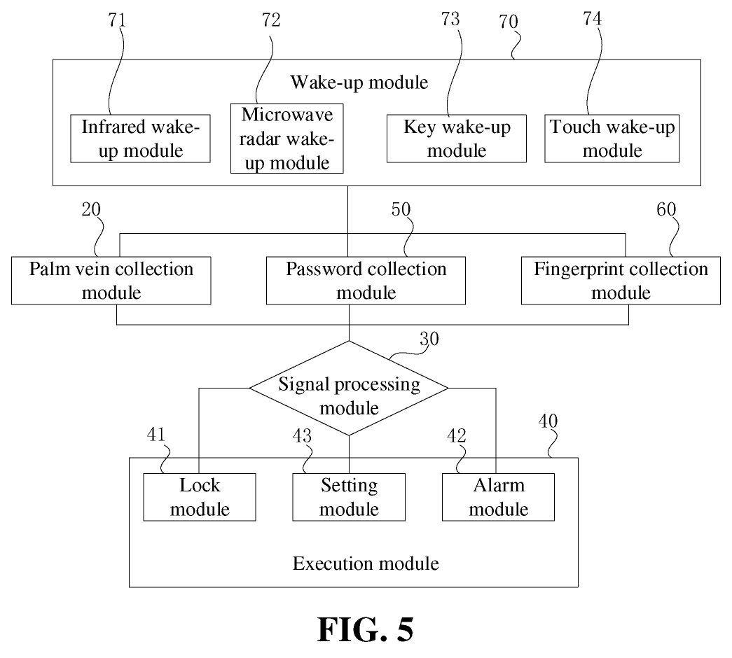

For the article storage device in the present disclosure, in addition to unlocking the lock module 41 based on the palm vein information, the lock module 41 may be unlocked by other means. In some embodiments, as shown in FIG. 5, the article storage device may further include a password collection module 50, a fingerprint collection module 60, and so on. The password collection module 50 and the fingerprint collection module 60 may be signally connected to the signal processing module 30. Specifically, the password collection module 50 may be configured to obtain password information and transmit the password information to the signal processing module 30. The fingerprint collection module 60 may be configured to collect fingerprint information of the user and transmit the fingerprint information to the signal processing module 30. The password collection module 50, the fingerprint collection module 60, and the palm vein collection module 20 may be configured independently from each other. In this way, a plurality of unlocking means may be provided to be applicable in various scenarios.

The signal processing module 30 may be configured to receive the password information and the fingerprint information. The password information and the fingerprint information of the authorized user may be registered into the preset information database in advance. When newly-received password information and/or newly-received fingerprint information successfully match the password information and/or the fingerprint information that is in-advance registered in the preset information database, the first execution signal may be generated. When the newly-received password information and/or the newly-received fingerprint information fails to match the password information and/or the fingerprint information that is in-advance registered in the preset information database, the second execution signal may be generated.

In order to improve error tolerance, for the case that the newly-received password information and/or the newly-received fingerprint information fails to match the password information and/or the fingerprint information that is in-advance registered in the preset information database, three attempts may be allowed. Only when the newly-received password information and/or the newly-received fingerprint information fails to match, for three consecutive times, the password information and/or the fingerprint information that is in-advance registered in the preset information database, the signal processing module 30 may generate the second execution signal, and then the alarm module 42 may start operating.

In order to permit the user to perform modification on and input information into the preset information database, in some embodiments, when any one of the palm vein information, the password information, or the fingerprint information successfully matches the respective information (the palm vein information, the password information, or the fingerprint information, respectively) that is registered in advance in the preset information database, the signal processing module 30 may simultaneously generate a third execution signal. The at least one execution module 40 may further include the setting module 43. The setting module 43 may be associated with the preset information database. When the setting module 43 receives the third execution signal, the setting module 43 grants access to the preset information database for setting, enabling the user to edit any information that is in-advance registered in the preset information database. For example, the user may modify information that is in-advance registered in the preset information database or may add new information (such as information of a new user) into the preset information database. In some embodiment, the setting module 43 may be an operation panel mounted on a surface of the storage body portion 11 or an operation panel that is arranged independently of the storage device body 10. The operation panel may be electrically connected or wirelessly connected to the control circuit board, and the user may modify any information saved in the preset information database via the operation panel.

In some embodiments, the palm vein collection module 20 may be arranged on the storage body portion 11 or the cover body 12.

In some embodiments, the palm vein collection module 20 may be arranged independently of the storage device body 10 to enable the user to remotely unlock the cover body 12.

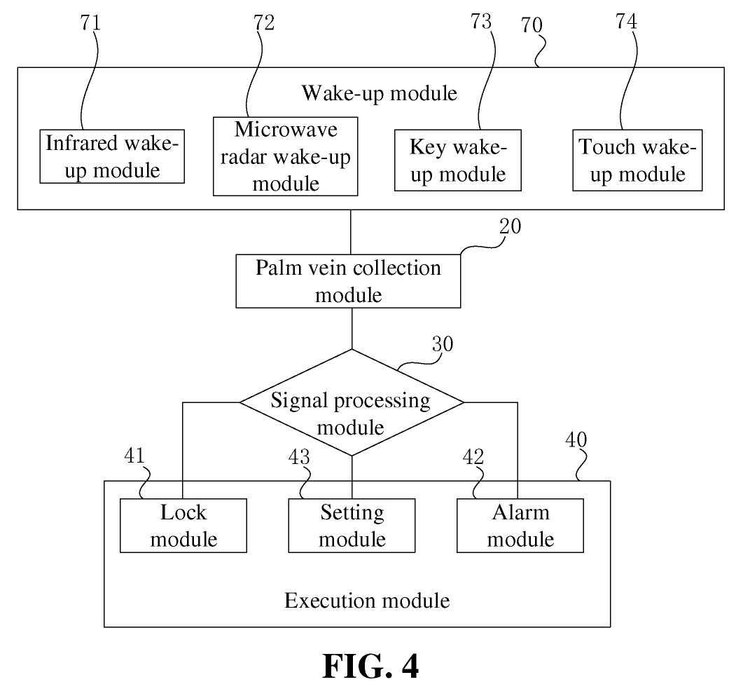

In order to save power consumption, in some embodiments, as shown in FIGS. 4 and 5, the article storage device may further include at least one wake-up module 70. The at least one wake-up module 70 may be signally connected to the palm vein collection module 20/the fingerprint collection module 60, specifically in a wired or wireless signal connection manner. The palm vein collection module 20 and the fingerprint collection module 60 may be in a normally-off state, such that power consumption may be saved when the device is in an idle state. When at least one of the at least one wake-up module 70 is awakened, a wake-up signal may be emitted to activate the palm vein collection module 20/fingerprint collection module 60.

The at least one wake-up module 70 may include at least one of: an infrared wake-up module 71, a microwave radar wake-up module 72, a key wake-up module 73, and a touch wake-up module 74. The infrared wake-up module 71 may be an infrared sensor mounted on the storage device body 10. The microwave radar wake-up module 72 may be a microwave radar sensor mounted on the storage device body 10. The key wake-up module 73 may be a functional key that is mounted on the storage body portion and can be pressed to be activated. The touch wake-up module 74 may be a piezoresistive sensor.

In some embodiments, the article storage device may be arranged with at least the infrared wake-up module 71. The infrared wake-up module 71 may include a second infrared emitter unit 711 and a photoelectric signal unit 712. The second infrared emitter unit 711 may be configured to emit the infrared light, and the photoelectric signal unit 712 may be configured to: receive the reflected light that is generated by the infrared light (emitted from the second infrared emitter unit 711) being reflected from an object; and transmit the wake-up signal to the palm vein collection module 20.

In some embodiments, the second infrared emitter unit 711 may be arranged independently from the first infrared emitter unit 21. In this case, the first infrared emitter unit 21 and the image capturing unit 22 may both be in a normally-off state, and the second infrared emitter unit 711 may be in a normally-on state.

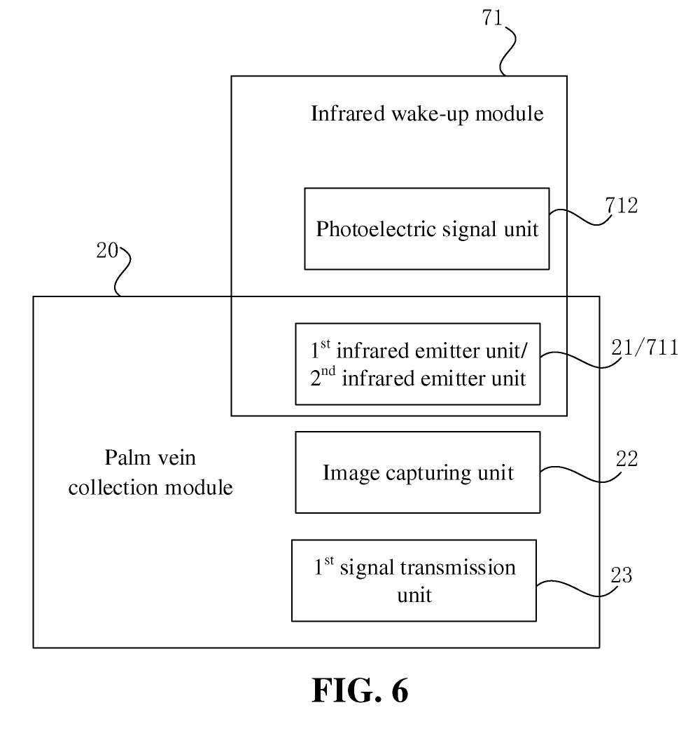

In some embodiments, as shown in FIG. 6, the first infrared emitter unit 21 and the second infrared emitter unit 711 may be the same infrared lamp or infrared emitter. In this case, the first infrared emitter unit 21 may be in the normally-on state, and the image capturing unit 22 may be in the normally-off state. Correspondingly, an obtaining window 111 may be provided on the storage body portion 11, and the palm vein collection module 20 and the infrared wake-up module 71 may both be located within the obtaining window 111. When the palm of the user is placed in front of the obtaining window 111, the infrared wake-up module 71 may be firstly triggered. Subsequently, the infrared wake-up module 71 may wake up the image capturing unit 22 to collect the palm vein information.

In some embodiments, no wake-up module 70 may be provided, and the palm vein collection module 20 may be set in the normally-on state.

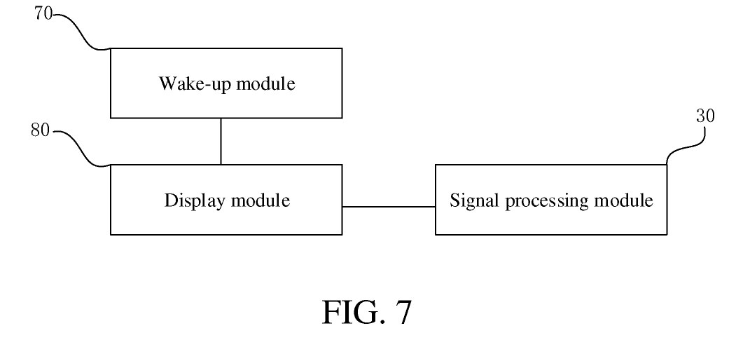

In some embodiments, as shown in FIGS. 1 and 7, the article storage device may further include a display module 80 and a power supply. The display module 80 may be mounted on the storage body portion 11, and the power supply may be arranged inside the storage body portion 11. The display module 80 may be electrically connected to the power supply and the signal processing module 30, and may be at least configured to display power level information of the power supply. In addition, the display module 80 may be a touch screen and may serve as the operation panel as described in the above. The user may perform an operation on the touch screen to adjust the preset information database.

In some embodiments, the display module 80 may be in a normally-on state, continuously displaying information. In some embodiments, the display module 80 may operate cooperatively with the wake-up module 70. In this way, the display module 80 may be in a normally-off state, such that power consumption may be saved.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. An article storage device, comprising a storage body portion and a cover body, the article storage device further comprising:
a palm vein collection module, configured to collect palm vein information;
a signal processing module, being signally connected to the palm vein collection module and being configured to receive the palm vein information and generate at least one execution signal, wherein the at least one execution signal comprises a first execution signal; and
at least one execution module, comprising a lock module, wherein the lock module is configured to receive the first execution signal to unlock the cover body.

2. The article storage device according to claim 1, wherein, the palm vein collection module comprises:
a first infrared emitter unit, configured to emit infrared light;
an image capturing unit, configured to: receive reflected light, which is generated by the infrared light emitted from the first infrared emitter unit being reflected by an object; and generate, based on the reflected light, a to-be-processed signal carrying the palm vein information; and
a first signal transmission unit, configured to transmit the to-be-processed signal to the signal processing module in a form of a wired or wireless signal.

3. The article storage device according to claim 2, wherein, the signal processing module comprises:
a recognition and comparison unit, configured to recognize the to-be-processed signal and generate the first execution signal when the palm vein information carried in the to-be-processed signal is recognized as matching preset information; and
a second signal transmission unit, configured to transmit the first execution signal to the at least one execution module in a form of a wired or wireless signal.

4. The article storage device according to claim 3, wherein:
the at least one execution signal further comprises a second execution signal, the recognition and comparison unit is configured to generate the second execution signal when recognizing that the palm vein information carried in the to-be-processed signal does not match the preset information; and
the at least one execution module further comprises an alarm module, the alarm module is configured to receive the second execution signal to enable the alarm module to emit at least one of: a sound, a voice prompt, and a light.

5. The article storage device according to claim 3, wherein:
the at least one execution signal further comprises a third execution signal, the recognition and comparison unit is configured to generate the third execution signal when recognizing that the palm vein information carried in the to-be-processed signal matches the preset information; and
the at least one execution module further comprises a setting module, the setting module is configured to receive the third execution signal and edit the preset information.

6. The article storage device according to claim 1, further comprising a password collection module, wherein, the password collection module is signally connected to the signal processing module, and the password collection module is configured to obtain password information and transmit the password information to the signal processing module; and
wherein, the signal processing module is configured to receive the password information and generate the at least one execution signal.

7. The article storage device according to claim 1, wherein, the palm vein collection module is arranged on the storage body portion or the cover body.

8. The article storage device according to claim 1, wherein, the storage body portion and the cover body cooperatively form a storage device body, and the palm vein collection module is arranged independently from the storage device body.

9. The article storage device according to claim 1, wherein, the palm vein collection module is in a normally-on state.

10. The article storage device according to claim 1, wherein, the palm vein collection module is in a normally-off state; the article storage device further comprises at least one wake-up module, the at least one wake-up module is signally connected to the palm vein collection module and is configured to wake up the palm vein collection module to start operating.

11. The article storage device according to claim 10, wherein at least one obtaining window is provided on the storage body portion; the palm vein collection module and the at least one wake-up module are arranged within a same one obtaining window of the at least one obtaining window.

12. The article storage device according to claim 10, wherein, the at least one wake-up module comprises at least one of: an infrared wake-up module, a microwave radar wake-up module, a key wake-up module, and a touch wake-up module.

13. The article storage device according to claim 10, wherein, the palm vein collection module comprises a first infrared emitter unit, an image capturing unit, and a first signal transmission unit; the first infrared emitter unit is configured to emit infrared light; the image capturing unit is configured to: receive reflected light, which is from the emitted infrared light being reflected by an object, and generate a to-be-processed signal carrying the palm vein information based on the reflected light; the first signal transmission unit is configured to transmit the to-be-processed signal to the signal processing module in a form of a wired or wireless signal;
the at least one wake-up module comprises an infrared wake-up module; the infrared wake-up module comprises a second infrared emitter unit and a photoelectric signal unit; the second infrared emitter unit is configured to emit infrared light; the photoelectric signal unit is configured to receive reflected light, which is generated by the infrared light emitted from the second infrared emitter unit being reflected by an object; and
the second infrared emitter unit and the first infrared emitter unit are configured as one same infrared emitter; the first infrared emitter unit is in a normally-on state; and the image capturing unit is in a normally-off state; the photoelectric signal unit is configured to wake up the image capturing unit to start operating.

14. The article storage device according to claim 1, further comprising a display module, wherein the display module is mounted on the storage body portion and is signally connected to the signal processing module.

15. The article storage device according to claim 14, wherein, the display module is in a normally-off state; the article storage device further comprises at least one wake-up module that is signally connected to the display module and is configured to wake up the display module to start operating.
